(19) United States
(12) Patent Application Publication
(10) Pub. No.: US 2019/0254439 A1
(43) Pub. Date: Aug. 22, 2019

(54) VISCO-ELASTIC DAMPING ELEMENT BASED ON VISCO-ELASTIC MATERIALS

(71) Applicant: Covestro Deutschland AG, Leverkusen (DE)

(72) Inventors: Dirk ACHTEN, Leverkusen (DE); Thomas BÜSGEN, Leverkusen (DE); Dirk DIJKSTRA, Odenthal (DE); Roland WAGNER, Leverkusen (DE); Bettina METTMANN, Dormagen (DE); Nicolas DEGIORGIO, Krefeld (DE); Peter REICHERT, Dormagen (DE)

(21) Appl. No.: 16/346,916

(22) PCT Filed: Nov. 2, 2017
(86) PCT No.: PCT/EP2017/078011

§ 371 Date: May 2, 2019

(30) Foreign Application Priority Data
Nov. 4, 2016 (EP) 16197297.1

(51) Int. Cl. A47C 27/15; A47C 27/14; B29C 64/10

(52) U.S. Cl. CPC A47C 27/15; B29K 2075/00; B29C 64/10; A47C 27/148

(57) ABSTRACT

The invention relates to a method for producing a visco-elastic damping element comprising at least one visco-elastic spring element, characterized in that the visco-elastic spring element is structured from at least one visco-elastic material having a tan δ of at least 0.5, determined according to DIN 53535: 1982-03, and produced by means of a 3D printing method. The invention further relates to a visco-elastic damping element, which is produced or can be produced according to said method, and to a solid body comprising or consisting of a plurality of damping elements.

The invention relates to a process for the production of a viscoelastic damping body comprising at least one spring element comprising at least one viscoelastic material. The invention further relates to a viscoelastic damping body produced by, or which can be produced by, said process, and also to a volume body comprising or consisting of a large number of said damping bodies.

Damping bodies of the type mentioned in the introduction can by way of example be used in mattresses, as described in EP 1 962 644 A2. In that document, a large number of damping bodies are combined in the form of composite in a mattress.

DE 20 2005 015 047 U1 discloses a combination mattress composed of a large number of spring elements which adjoin one another at their peripheries and are held together by means of an encompassing belt. The spring elements have a groove for securing the belt. The spring elements are produced from latex.

There are moreover known spring-core mattresses which have metal springs as spring elements introduced into fabric pockets. Another term used for the resultant metal spring core is Bonnell spring core or pocket spring core. Positioned above the metal spring core there is foam cushioning, generally manufactured from block foam and having a certain elasticity. There are moreover known foam mattresses with wire springs incorporated into the foam core.

DE 299 18 893 U1 discloses a cushioning element which is intended for furniture and mattresses and which has a large number of spring elements placed together to give a surface-area composite. The spring elements here have been manufactured from sheep's wool and inserted into pockets preferably produced from cotton, where the upper ends of the pocket springs form the subsequent load-bearing area. A large-surface-area cushioning element is created by arranging a large number of the spring elements alongside one another and connecting, preferably stitching, these to one another respectively in individual rows.

DE 39 37 214 A1 moreover discloses a cushioning element for supporting a human body in horizontal position. A mattress component made of resilient material such as foam has, arranged alongside one another, a large number of channels into which inserts of different resilience have been inserted in a manner such that the mattress component has, across its supportive surface, regions of different local resilience. The inserts can consist of a resilient material corresponding to that of the mattress component.

DE 10 2015 100 816 B3 describes a process for the production of a body-support element, for example a mattress, by means of a 3D printer, on the basis of print data. By using the 3D printer, it is possible on the basis of the print data to produce regions of different resilience by forming cavities of different sizes and/or in different numbers.

WO 2007/085548 A1 moreover discloses that viscoelastic flexible polyurethane foams can be used as material for mattresses.

The above processes are attended by various disadvantages: when mattresses are produced from viscoelastic flexible polyurethane foams, the possibilities for individual matching of damping properties to respective requirements are limited. An additional factor in the case of the conventional methods for the production of spring-core mattresses is that the bringing-together of the individual modules is complicated. Here again, the possibilities for local matching of damping properties are very limited because of the size of the coil spring used, which are subject to restrictions resulting from their design. The manufacturing processes are difficult to individualize and here again are almost incapable of providing useful and cost-effective individualized manufacture.

It was therefore the object of the invention to provide, for the production of a viscoelastic damping body, a process that permits production of damping bodies with individually adjustable viscoelastic behavior together with high local resolution. The resultant damping bodies are intended by way of example to be suitable as mechanical vibration dampers or for use for a mattress.

The object is achieved for a viscoelastic damping body of the type mentioned in the introduction in that the viscoelastic damping body is produced by way of a 3D printing process with use of at least one material that is viscoelastic at usage temperature.

The invention therefore provides a process for the production of a viscoelastic damping body comprising at least one viscoelastic spring element, the process here being characterized in that the viscoelastic spring element is composed of at least one viscoelastic material with tan δ of at least 0.5, determined in accordance with DIN 53535:1982-03, and is produced by way of a 3D printing process.

The present invention is based on the discovery that with the aid of a 3D printing process it is possible to achieve individualized damping properties. The term “individualized” here means not only that production of individual units is possible in a useful and cost-effective manner but also that damping properties of a damping body at different points within the body can be adjusted as desired, and with high local resolution. It is thus possible by way of example to achieve individualized production of a mattress in accordance with the anatomical requirements or needs of a customer. By way of example, in order to achieve optimized pressure distribution for lying on the mattress, a pressure profile of the body can first be recorded on a sensor surface, and the resultant data can be used to individualize the mattress. The data are then introduced in a manner known per se into the 3D printing process.

The 3D printing process can by way of example be selected from melt layering (fused filament fabrication, FFF), ink-jet-printing, photopolymer jetting, stereo lithography, selective laser sintering, digital-light-processing-based additive manufacturing system, continuous liquid interface production, selective laser melting, binder-jetting-based additive manufacturing, multijet-fusion-based additive manufacturing, high-speed sintering process and laminated object modelling.

The expression “Fused Filament Fabrication” (FFF; sometimes also termed melt printing or plastic jet printing (PJP)) as used herein means an additive manufacturing process which constructs a workpiece layer-by-layer, for example from a fusible plastic. The plastic can be used with or without further additions such as fibers. Machines for FFF are classified as 3D printers. This process is based on use of heat to liquefy a material in the form of a wire consisting of plastic or of wax. The material is finally solidified by cooling. The material is applied via extrusion, using a heated nozzle which can be moved freely in relation to a manufacturing plane. It is possible here either that the manufacturing plane is fixed and that the nozzle can be moved freely or that a nozzle is fixed and that a substrate table (with a manufacturing plane) can be moved, or that both elements, nozzle and manufacturing plane, can be moved. The velocity with which the substrate and nozzle can be moved in relation to one another is preferably in the range from 1 to 200 mm/s. The layer thickness is in the range from 0.025 to 1.25 mm, as required by the application, and the output diameter of the jet of material from the nozzle (nozzle outlet diameter) is typically at least 0.05 mm.

In the case of layer-by-layer model production, the individual layers thus become bonded to give a complex component. In the usual procedure for the construction of a body, an operating plane is traversed repeatedly, line by line (formation of a layer), and then the operating plane is shifted upward in “stacking” mode (formation of at least one further layer on the first layer), the result therefore being layer-by-layer production of a shaped body. The output temperature of the mixtures of materials from the nozzle can by way of example be from 80° C. to 420° C. It is moreover possible to heat the substrate table, for example to from 20° C. to 250° C. Excessively rapid cooling of the applied layer can thus be prevented, so that a further layer applied thereto bonds sufficiently to the first layer.

The viscoelastic damping body of the invention can exhibit damping properties in any desired spatial direction. Nor is the nature of the deformation of any major importance. The viscoelastic damping body can therefore be subjected inter alia to compressive, tensile, torsional or flexural deformation, with resultant damping of these.

For the purposes of the present invention, the viscoelastic damping body can by way of example consist of spring elements which have various spatial orientations and are direction-dependent in their springing and damping effects, these in turn being based on energy-elastic materials with tan δ<0.5 and on at least one viscoelastic material with δ≥0.5 at usage temperature, for example 25° C. The effective spring force within the three-dimensional volume is determined via the modulus of the material and geometric factors such as the wall thickness and spatial orientation of the spring elements. The damping is controlled via the damping provided by the viscoelastic spring element, and also the length and the design, and also the contribution of the viscoelastic spring elements, based on overall modulus.

The arrangement of various geometric damping bodies and other spring elements defined as energy-elastic, and also optionally of additional deformation-limiting elements in the space enclosed by the damping body (closed or open) permits targeted construction of viscoelastic 3D damping bodies having either symmetrical or asymmetrical action. The individual spring elements here can be mechanically coupled or mechanically coupled and positionally fixed. It is preferable that all of these spring elements are produced by means of additive 3D printing methods of manufacture. It is possible here to use various additive manufacturing technologies in parallel or in series.

The modulus or “springing capability” of the damping bodies of the invention is stated in terms of their compressive strength in accordance with DIN EN ISO 3386-1 for low-density flexible resilient foams and DIN EN ISO 3386-2 for high-density flexible resilient foams as compression resistance in kPa.

The compressive strength of the damping body of the invention is preferably in the range from 0.01 to 1000 kPa. Compressive strength in accordance with DIN EN ISO 3386-1:2010-09 of the damping body of the invention for compression to 40% of its initial height is preferably in the range from 0.1 to 500 kPa, more preferably in the range from 0.5 to 100 kPa.

The term “viscoelasticity” means, for a material, behavior that is to some extent elastic and to some extent viscous. Viscoelastic materials therefore combine, within themselves, features of liquids and of solids. The effect is time-, temperature- and frequency-dependent, and occurs in polymer melts and solids such as plastics and also in other materials.

The elastic component in principle brings about spontaneous, limited, reversible deformation, while the viscous component in principle brings about time-dependent, unlimited, irreversible deformation. The viscous and elastic components are present to different extents in viscoelastic materials, and the nature of their combined effect also differs.

In rheology, elastic behavior is represented by a spring, the Hookean element, and viscous behavior is represented by a damping cylinder, the newtonian element. Viscoelastic behavior can be modelled by combining two or more of these elements.

One of the simplest viscoelastic models is the Kelvin body, in which spring and damping cylinder are installed in parallel. On exposure to load, e.g. due to tension, deformation is retarded by the damping cylinder and its extent is limited by the spring. After removal of the load, the Hookean element causes the body to return to its initial state. The Kelvin body therefore deforms in a manner that is time-dependent, like a liquid, but limited and reversible, like a solid.

All liquids and solids can be considered as viscoelastic materials by stating their storage modulus and loss modulus, G′ and G″, or their loss factor tan δ−G″/G′. In the case of ideally viscous liquids (newtonian fluids), the storage modulus is very small in comparison with the loss modulus, and in the case of ideally elastic solids belonging to Hook's law the loss modulus is very small in comparison with the storage modulus. Viscoelastic materials have both a measurable storage modulus and a measurable loss modulus. If the storage modulus is greater than the loss modulus, the term solid is used; in other cases, the term liquid is used.

The loss factor is therefore a measure for the damping provided by a viscoelastic body. The damping tan δ exhibited by the damping body of the invention in the event of compressive or tensile deformation, in the direction of deformation, is with preference from 0.5 to 2, in particular from 0.5 to 0.9, preferably from 0.5 to 0.8, measured in accordance with DIN 53535:1982-03: Testing of rubber and elastomers; general requirements for dynamic testing. A good balance is obtained here between damping effect and springing effect; this is particularly advantageous for the use in mattresses.

For applications with the damping bodies of the invention relating to the human body, for example for mattresses, helmets or protectors, it is preferable that compressive strength in accordance with DIN EN ISO 3386-1 is in the range from 0.5-100 kPa, damping being in the range from 0.1-1.

Residual deformation is determined in accordance with DIN ISO 815-1:2010-09: rubber, vulcanized or thermoplastic—Determination of compression set. The standard determines compression set (CS) at constant deformation. A CS of 0% means that the body has completely regained its initial thickness, and a CS 100% indicates that the body has been completely deformed during the test and exhibits no recovery. The formula used for the calculation is: CS (%)=(L0−L2)/(L0−L1)×100% where:

CS=compression set in %

L0=height of test sample before test

L1=height of test sample during test (spacer)

L2=height of test sample after test

The indefinite article “a” generally means “at least one”, i.e. “one or more”. The person skilled in the art is aware that in certain situations the intended meaning has to be “one” or “1” rather than the indefinite article, and that the indefinite article “a” also concomitantly comprises, in one embodiment, the definite article “one” (1).

In an advantageous embodiment of the process of the invention, the compression set of the damping body after 10% compression is ≤5%, measured in accordance with DIN ISO 815-1, in particular ≤3%, preferably ≤2%. This is advantageous because the resilience of this type of damping body is very substantially identical on every occasion when a new load is applied. In the case of a mattress, this results in very substantial avoidance of any visible compression.

The damping tan δ exhibited by the damping body of the invention in the event of compressive or tensile deformation, in the direction of deformation, is preferably from 0.05 to 2, in particular from 0.1 to 1, measured in accordance with DIN 53535:1982-03. In other words, therefore, the damping exhibited by the damping body can differ from that exhibited by the individual damping element. This is made possible by combining damping elements with different damping behavior, and spring elements, with the damping bodies of the invention in a manner such that the abovementioned values for the damping body in its entirety corresponds to the abovementioned values.

In a preferred embodiment of the process of the invention, the damping body is configured to some extent or completely as open-celled hollow body, and has at least one open passage, and when subject to compressive or tensile deformation preferably exhibits damping tan δ, measured in accordance with DIN 53535, of from 0.1 to 1 in the direction of deformation. This is advantageous because with the aid of the 3D printing process it is thus possible to create modules in which by way of example air or another fluid responsible for be an additional damping effect, where damping behavior can easily be adjusted appropriately via the production process of the invention. The volume of the damping body can by way of example be from 1000 L to 100 mL, in particular from 700 L to 1 L, very particularly from 500 L to 2 L.

Open damping bodies can be produced during the production or else only after the production of the hollow body. The latter can be achieved by way of example via chemical dissolution or melting of a sacrificial material from the overall volume of the damping body. The expression “sacrificial material” means a material that is not part of the finished damping body but instead is used only during the production of the damping body in order by way of example to support structures during layer-by-layer construction via 3D printing process with the construction material(s) that form the damping body, or in order to permit production of overhangs. Examples of sacrificial materials used are waxes with melting point lower than that of the construction material(s), or else materials soluble in another solvent in which the construction material(s) is/are not soluble. For non-water-soluble construction materials, it is possible by way of example to use water-soluble polyvinyl alcohol (PVA) as sacrificial material, and for acrylonitrile-butadiene-styrene (ABS) as construction material it is possible to use high-impact polystyrene (HIPS) as sacrificial material which, unlike ABS, dissolves in acetone.

A damping body of the invention can preferably show a compressive strength in accordance with DIN EN ISO 3386-1 of from 0.01 to 1000 kPa for compression to 40% of its original height, and/or damping tan δ in accordance with DIN 53535 of from 0.1 to 1 and/or a compression set in accordance with DIN ISO 815-1 of 5% after 10% compression, preferably <8% after 20% compression and very preferably <15% after 40% compression.

Another preferred embodiment is directed to the production of a 3D damping body where the 3D damper element exhibits residual deformation, after 40% compression, of <10% of the initial component height.

In a particularly preferred embodiment, the viscoelastic damping body features a modulus of elasticity of the construction materials used of <2 GPa, in particular of from 1 to 1000 MPa, preferably from 2-500 MPa, in accordance with DIN EN ISO 604: 2003-12.

Said damping body can be produced by way of example by a process of the invention which comprises at least one of the following steps:
I) in a suitable CAD program, design of a damping body with a localized, temperature-dependent and direction-dependent damping profile,
II) transfer of CAD data set into production instructions for a 3D printer,
III) 3D printing of a hollow air-permeable damping body consisting of at least one spring element with viscoelastic properties and optionally of other coupled spring elements,
IV) optionally “dissolution” to remove supportive material.

Another preferred embodiment of the process of the invention comprises, alongside any of the preceding steps I) to IV), either of the further steps of:
V) Combination of the damping body of the invention with conventional materials.
VI) The optionally reversible mechanical or chemical fixing of the damping body of the invention in a retaining frame.

In a preferred embodiment, a plurality of damping bodies are connected to one another by way of bridging materials to give a product with viscoelastic properties, for example a mattress, a seat, a helmet, or a shoe.

In another preferred embodiment, the damping body comprises at least one elastic material with a modulus of elasticity in preferential direction of deformation of <2 GPa and material-specific damping tan δ<0.2 at usage temperature, in particular at 25° C., where the damping body in its entirety has a modulus in preferential direction of deformation and at usage temperature of <1 GPa and tan δ>0.2.

In a preferred embodiment of the process of the invention, the spring element is designed in a manner such that the compressive strength of the damping body is from 0.1 to 500 kPa, measured in accordance with DIN EN ISO 3386-1, in particular from 0.5 to 100 kPa.

In a particular embodiment, an individual or a plurality of spring elements which are part of the damping body has, at usage temperature, which is preferably in the range from 10 to 40° C., a modulus of elasticity in preferential direction of deformation of by way of example from 10 Pa to 2 GPa.

The spring element can by way of example be configured as compression spring, tension spring, leg spring, torsion spring, helical spring, membrane spring, leaf spring, disk spring, air spring, gas compression spring, annular spring, volute spring or coil spring. In a particular embodiment, part of the spring elements can consist of metallic materials. It is also possible here to use a plurality of the abovementioned types in a damping body, for example in order to establish different springing behavior at different locations of the damping body.

It is possible in the process of the invention that a large number of elastic and viscoelastic spring elements have been installed in parallel and/or in sequence with one another, and have at least to some extent been coupled to one another. These elastic and viscoelastic spring elements cannot therefore be deformed independently of one another. The coupling to one another can be achieved by way of example by jointing techniques known per se, for example adhesion or welding, or else before the end of the production process in a manner such that the individual elements have no prior separate existence.

The tensile modulus of the materials used for the damping element in the process of the invention can be <250 GPa, measured in accordance with DIN EN ISO 6892-1:2009-12, in particular from 0.05 to 150 GPa. The material can by way of example have reinforcement by carbon fibers, aramid fibers, or glass fibers in the direction of tension in order to achieve excellent tensile stability values alongside the damping in the direction of deformation.

The damping body can be composed of one, or else of two or more different, material(s), for example of from 2 to 10 different materials, in particular of more than 3 different materials, for example 3 to 8 different materials. Different spring elements can be composed of identical or different materials.

The hardening of the materials used can be achieved via cooling of metals or thermoplastics, via low-temperature or high-temperature polymerization, or via polyaddition, polycondensation, addition or condensation, or via electron-initiated or electromagnetic-radiation-initiated polymerization.

The material of the spring elements can be selected mutually independently from metals, plastics and composites, in particular from thermoplastically processible plastics formulations based on polyamides, polyurethanes, polyesters, polyimides, polyethers, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, rubber materials, and also mixtures and copolymers of at least two thereof.

The material of the spring element and of the damping element is particularly preferably selected from thermoplastic elastomers (TPEs), thermoplastic polyurethane (TPU), polycarbonate (PC), polyamide (PA), polyethylene terephthalate (PET), polybutylene terephthalate (PBT), cycloolefinic copolyester (COC), polyetherketone (PEEK), polyetheramideketone (PEAK), polyetherimide (PEI) (e.g. Ultem), polyimide (PI), polypropylene (PP) or polyethylene (PE), acrylonitrile-butadiene-styrene (ABS), polylactate (PLA), polymethyl methacrylate (PMMA), polystyrene (PS), polyvinyl chloride (PVC), polyoxymethylene (POM), polyacrylonitrile (PAN), polyacrylate, celluloid and mixtures of at least two thereof. It is preferable that the material is selected from a group consisting of TPE, TPU, PA, PEI, and PC, particularly from a group selected from TPU and PC.

It is likewise possible to use materials selected from reactive-curing systems.

The material of the spring element and/or of the damping element can comprise at least one additive, e.g. fibers, UV hardeners, peroxides, diazo compounds, sulfur, stabilizers, inorganic fillers, plasticizers, flame retardants and antioxidants. Examples of these additives are Kevlar fibers, glass fibers, aramid fibers, carbon fibers, rayon, cellulose acetate, and/or familiar natural fibers (e.g. flax, hemp, coir, etc.). The substance mixtures can comprise, alongside or instead of fibers, reinforcing particles, in particular selected from inorganic or ceramic nanopowders, metal powders or plastics powders, for example from SiO₂ or Al₂O₃, AlOH₃, RuB, TiO₂ or CaCO₃. Substance mixtures can moreover also comprise by way of example peroxides, diazo compounds and/or sulfur.

In particular when reactive resins are used, mixtures of two or more reactive resins can have been mixed in advance, or are mixed on the substrate. In the latter case, application can take place from different nozzles by way of example. The hardenable substance mixtures can differ in their nature, but under the conditions of the process of the invention must be low- or high-viscosity liquid extrudable plastics compositions or liquid printable plastics compositions. These can be thermoplastics, silicones, or else hardenable reactive resins, i.e. two-component polyurethane systems, two-component epoxy systems, or moisture-curing polyurethane systems, air-curing or free-radical-curing unsaturated polyesters, or UV-curing reactive resins based on, for example, vinyl compounds and acrylic compounds as described inter alia in EP 2 930 009 A2 and DE 10 2015100 816.

The damping body of the invention is generally produced layer-by-layer. In the case of reactive systems, after application of a first layer and optionally application of further layers to produce a surface section, the applied material can by way of example be hardened by low- or high-temperature polymerization, polyaddition or polycondensation, addition (e.g. PU addition) or condensation, or else initiation by electron beam or by electromagnetic radiation, in particular UV radiation. Heat-curing plastics mixtures can be hardened by using an appropriate source of IR radiation.

The prior art describes various two- or multicomponent systems amenable to printing: by way of example DE 199 37 770 A1 discloses a two-component system comprising an isocyanate component and an isocyanate-reactive component. Droplet jets are produced from both components and are directed in a manner such that they combine to form a combined droplet jet. The reaction of the isocyanate component with the isocyanate-reactive component begins in the combined droplet jet. The combined droplet jet is guided onto a substrate material, where it is used for the construction of a three-dimensional body, with formation of a polymeric polyurethane. EP 2 930 009 A2 describes a process for the printing of a multicomponent system comprising at least one isocyanate component and at least one isocyanate-reactive component, these being particularly suitable for inkjetting processes by virtue of their reactivity and miscibility.

Another object of the present invention further provides a viscoelastic damping body produced by, or which can be produced by, the process of the invention.

The invention moreover provides a volume body comprising or consisting of a large number of damping bodies of the invention where the volume body in particular is a mattress.

The volume body of the invention is preferably composed of at least two damping bodies.

The invention also provides a mechanical damper, for example a damped telescopic strut, comprising at least one damping body of the invention.

The invention moreover provides the use of one or more damping bodies produced in according to the invention as a volume body preferably for supporting parts of the human body. The volume body is preferably selected from the group consisting of a mattress, a cushion, a seat, a sofa, preferably a sofa part, a chair, preferably a chair part, a pad, a helmet, a body-protector, an orthopedic protective element, preferably a part of an orthopedic protective element, a shoe and parts thereof, and combinations of at least two thereof. The volume body is preferably for use as support for parts of the human body selected from the group consisting of a mattress, a cushion, a seat, a pad and parts thereof and combinations of at least two thereof.

A first subject matter of the invention provides a process for the production of a viscoelastic damping body comprising at least one viscoelastic spring element, characterized in that the viscoelastic spring element is composed of at least one viscoelastic material with tan δ of at least 0.5, determined in accordance with DIN 53535:1982-03, and is produced by way of a 3D printing process.

A second subject matter of the invention provides a process as in subject matter 1, characterized in that the tan δ of the viscoelastic material is from 0.5 to 0.9, determined in accordance with DIN 53535:1982-03, in particular from 0.5 to 0.8.

A third subject matter of the invention provides a process as in either of the preceding subject matters, characterized in that the viscoelastic material is selected from thermoplastically processible plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and mixtures and copolymers of at least two thereof.

A fourth subject matter of the invention provides a process as in subject matter 3, characterized in that the viscoelastic material is selected from thermoplastically processible plastics formulations based on polyacrylates, polyurethanes and their mixtures and copolymers of at least two thereof.

A fifth subject matter of the invention provides a process as in any of the above subject matters, characterized in that the viscoelastic spring element is configured as partially or completely fluid-filled hollow body and comprises at least one open passage, the fluid being in particular selected from air, nitrogen, carbon dioxide, oils, water, hydrocarbons or hydrocarbon mixtures, ionic liquids, electro-rheological, magneto-rheological, Newtonian, viscoelastic, rheopectic and thixotropic liquids and mixtures of at least two thereof.

A sixth subject matter of the invention provides a process as in subject matter 5, characterized in that during deformation of the viscoelastic spring element from its unloaded state the fluid-viscoelasticity provides at most 10% of the overall viscoelasticity of the viscoelastic spring element, in particular at most 5%, preferably at most 1%, particularly preferably less than 0.5%.

A seventh subject matter of the invention provides a process as in any of the preceding subject matters, characterized in that the compressive strength of the viscoelastic spring element is from 0.01 to 1000 kPa, measured in accordance with DIN EN ISO 3386-1:2010-09, in particular from 0.1 to 500 kPa, or from 0.5 to 100 kPa.

An eighth subject matter of the invention provides a process as in any of the preceding subject matters, characterized in that a large number of viscoelastic spring elements are placed in parallel and/or sequentially in relation to one another and at least to extent coupled to one another, where the viscoelastic spring elements are identical or different.

A ninth subject matter of the invention provides a process as in any of the preceding subject matters, characterized in that the compression set on the damping body after 10% compression is <2%, measured in accordance with DIN ISO 815-1:2010-09.

A tenth subject matter of the invention provides a process as in any of the preceding subject matters, characterized in that the damping tan δ exhibited by the damping body in compressive or tensile deformation in the direction of deformation is from 0.05 to 2, in particular from 0.1 to 1, measured in accordance with DIN 53535:1982-03.

An eleventh subject matter of the invention provides a process as in any of the preceding subject matters, characterized in that the 3D printing process is selected from melt layering (fused filament fabrication, FFF), ink-jet-printing, photopolymer jetting, stereo lithography, selective laser sintering, digital-light-processing-based additive manufacturing system, continuous liquid interface production, selective laser melting, binder-jetting-based additive manufacturing, multijet-fusion-based additive manufacturing, high-speed sintering process and laminated object modelling and combinations of at least two thereof.

A twelfth subject matter of the invention provides a process as in any of the preceding subject matters, characterized in that the tensile modulus of the materials used in the damping body is <250 GPa, measured in accordance with DIN EN ISO 6892-1:2009-12, in particular from 0.05 to 150 GPa.

A thirteenth subject matter of the invention provides a process as in any of the preceding subject matters, characterized in that the material of the spring element and of the damping body is mutually independently selected from metals, plastics and composites, in particular from thermoplastically processible plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and their mixtures and copolymers of at least two thereof.

A fourteenth subject matter of the invention provides a viscoelastic damping body produced by, or which can be produced by, a process as in any of the subject matters 1 to 13, where the damping body in particular has one or more of the following properties:
hollow volume: from 1 μL to 1 L, preferably from 10 μL to 100 mL
thickness of material: 10 μm to 1 cm, preferably from 50 μm to 0.5 cm
diameters of open passages: from 10 to 5000 μm
number of pores/cm² of external area: from 0.01 to 100
area of pores/cm² of external area: from 0.1 to 10 mm²

modulus of elasticity in accordance with DIN EN ISO 604: 2003-12 of material used: <2 GPa, in particular from 1 to 1000 MPa, preferably from 2-500 MPa.

A fifteenth subject matter of the invention provides a volume body comprising or consisting of a large number of damping bodies as in subject matter 14, where the volume body in particular is a mattress.

The invention is explained in more detail below with reference to two figures.

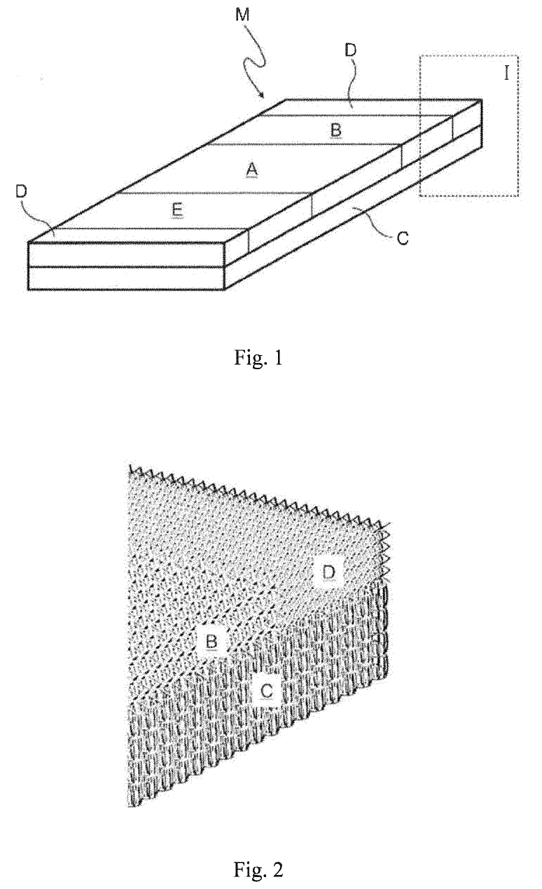

FIG. 1 is a three-dimensional diagram showing, obliquely from above, a volume body of the invention in the form of a mattress, and

FIG. 2 shows the structure of the section identified by “I” in FIG. 1 of the volume body as produced in the 3D printer.

FIG. 1 is a three-dimensional diagram showing, obliquely from above, a volume body M of the invention in the form of a mattress. The mattress M has been divided into different sections A, B, C, D, E. The mattress M has been divided here horizontally into the section C on the one hand and, on the other hand, the sections A, B, D and E. Section C is the underside of the mattress; the sections D are the top and bottom edge area of the mattress which, during sleep, are not generally subject to any particular load; section E is the head and shoulder area; section A is the trunk area, and section B is the leg area. The individual sections here differ in their damping behavior and their compressive strength in the following manner:

| Section | tan δ | Compressive strength [kPa] |
|---|---|---|
| A | 0.3-0.4 | 30-35 |
| B | 0.2-0.3 | 35-40 |
| C | 0.1-0.15 | 40-50 |
| D | 0.1-0.15 | 35-40 |
| E | 0.1-0.2 | 30-35 |

As can be seen from FIG. 1, compressive strength and damping behavior can be adjusted individually and in localized manner as required by the particularly physiological characteristics of an individual person. The 3D printing process is used here to produce a large number of damping elements, and also if desired spring elements, which then combine to achieve the abovementioned values relating to tan δ and to compressive strength.

A dashed line in FIG. 1 moreover identifies an area I. This is depicted in enlarged form in FIG. 2. The sections B, C, D are again shown therein, as also is the structure produced for these by a 3D printer during the production process. It can clearly be seen in FIG. 2 that the structure of the printed repeating units are different in the individual sections B, C, D, giving different damping behavior and different compressive strength.

1.-15. (canceled)

16. A process for the production of a viscoelastic damping body comprising at least one viscoelastic spring element, wherein the viscoelastic spring element is composed of at least one viscoelastic material with tan δ of at least 0.5, determined in accordance with DIN 53535:1982-03, and is produced by way of a 3D printing process.

17. The process as claimed in claim 16, wherein the tan δ of the viscoelastic material is from 0.5 to 0.9, determined in accordance with DIN 53535:1982-03.

18. The process as claimed in claim 16, wherein the viscoelastic material is selected from thermoplastically processible plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and their mixtures and copolymers.

19. The process as claimed in claim 18, wherein the viscoelastic material is selected from thermoplastically processible plastics formulations based on polyacrylates, polyurethanes and their mixtures and copolymers.

20. The process as claimed in claim 16, wherein the viscoelastic spring element is configured as partially or completely fluid-filled hollow body and comprises at least one open passage, the fluid being in particular selected from air, nitrogen, carbon dioxide, oils, water, hydrocarbons or hydrocarbon mixtures, ionic liquids, electro-rheological, magneto-rheological, Newtonian, viscoelastic, rheopectic and thixotropic liquids and mixtures of these.

21. The process as claimed in claim 20 wherein during deformation of the viscoelastic spring element from its unloaded state the fluid-viscoelasticity provides at most 10% of the overall viscoelasticity of the viscoelastic spring element.

22. The process as claimed in claim 16, wherein the compressive strength of the viscoelastic spring element is from 0.01 to 1000 kPa, measured in accordance with DIN EN ISO 3386-1:2010-09.

23. The process as claimed in claim 16, wherein a large number of viscoelastic spring elements are placed in parallel and/or sequentially in relation to one another and at least to an extent coupled to one another, where the viscoelastic spring elements are identical or different.

24. The process as claimed in claim 16, wherein the compression set on the damping body after 10% compression is ≤2%, measured in accordance with DIN ISO 815-1:2010-09.

25. The process as claimed in claim 16, wherein the damping tan δ exhibited by the damping body in compressive or tensile deformation in the direction of deformation is from 0.05 to 2, measured in accordance with DIN 53535:1982-03.

26. The process as claimed in claim 16, wherein the 3D printing process is selected from melt layering (fused filament fabrication, FFF), ink-jet-printing, photopolymer jetting, stereo lithography, selective laser sintering, digital-light-processing-based additive manufacturing system, continuous liquid interface production, selective laser melting, binder-jetting-based additive manufacturing, multijet-fusion-based additive manufacturing, high-speed sintering process and laminated object modeling.

27. The process as claimed in claim 16, wherein the tensile modulus of the materials used in the damping body is <250 GPa, measured in accordance with DIN EN ISO 6892-1:2009-12.

28. The process as claimed in claim 16, wherein the material of the spring element and of the damping body is mutually independently selected from metals, plastics and composites, in particular from thermoplastically processible plastics formulations based on polyamides, polyurethanes, polyesters, polyimides, polyetherketones, polycarbonates, polyacrylates, polyolefins, polyvinyl chloride, polyoxymethylene and/or crosslinked materials based on polyepoxides, polyurethanes, polysilicones, polyacrylates, polyesters, and their mixtures and copolymers.

29. A viscoelastic damping body produced by, or which can be produced by, a process as claimed in claim 16, where the damping body in particular has one or more of the following properties:
hollow volume: from 1 μL to 1 L, preferably from 10 μL to 100 mL
thickness of material: 10 μm to 1 cm, preferably from 50 μm to 0.5 cm
diameters of open passages: from 10 to 5000 μm
number of pores/cm² of external area: from 0.01 to 100
area of pores/cm² of external area: from 0.1 to 10 mm²
modulus of elasticity in accordance with DIN EN ISO 604: 2003-12 of material used: <2 GPa,
in particular from 1 to 1000 MPa, preferably from 2-500 MPa.

30. A volume body comprising or consisting of a large number of damping bodies as claimed in claim 29, where the volume body in particular is a mattress.
